(19) United States
(12) Patent Application Publication
(10) Pub. No.: US 2018/0281319 A1
(43) Pub. Date: Oct. 4, 2018

(54) METHOD FOR PRODUCING A COMPONENT FROM A FIBER-COMPOSITE MATERIAL

(71) Applicant: Siempelkamp Maschinen- und Anlagenbau GmbH, Krefeld (DE)

(72) Inventors: Lothar SEBASTIAN, Duisburg (DE); Klaus SCHUERMANN, Juechen (DE); Michael SCHOELER, Rheurdt (DE)

(21) Appl. No.: 15/763,171

(22) PCT Filed: Oct. 18, 2016
(86) PCT No.: PCT/EP2016/074988

§ 371 Date: Mar. 26, 2018

(30) Foreign Application Priority Data
Oct. 20, 2015 (DE) 10 2015 117 857.5

(51) Int. Cl. B29C 70/44; B29C 70/34

(52) U.S. Cl. CPC B29C 70/44; B29K 2105/256; B29C 70/342

(57) ABSTRACT

The invention relates to a method for producing a component from a fibre composite material by deforming a thermoplastic organic sheet (2) in a membrane press (1), wherein a mould (4) is arranged in the membrane press (1), wherein at least one organic sheet (2) is positioned on or in the mould as a work piece, and wherein an elastically flexible membrane (11) is flexibly stretched over the mould (4) with the interposition of the organic sheet (2). In this way, the organic sheet (2) is deformed with the formation of the component, wherein the membrane (11) is applied with an under-pressure on the side facing the mould, and with an over-pressure on the side facing away from the mould, such that the organic sheet (2) is shaped onto the mould.

The invention relates to a method of making a (three-dimensional) part from a fiber composite material by deforming a (two-dimensional) thermoplastic organic sheet.

In the context of the invention, an “organic sheet” is a flat (consolidated) semifinished product consisting of fibers embedded in a matrix of a thermoplastic synthetic resin. The fibers can be present as continuous or long fibers, for example in the form of a fiber weave or fiber spunbond. The fibers can for ex ample be of carbon, glass, or aramid. Such organic sheets are used as fiber composite materials for making parts (for example lightweight design) for aerospace engineering (for example aircraft construction) and for automotive engineering (for example in automobile manufacture). The use of the thermoplastic fiber matrix allows such organic sheets to be (thermo)shaped like metal sheets, so that, in practice, methods for working metal sheets are used during the processing of organic sheets and during the manufacture of parts from such organic sheets.

For instance, DE 10 2011 115 730 describes a method for shaping thermoplastic semifinished fiber plates with oriented fibers into three-dimensional thermoplastic semifinished products with defined degrees of orientation, the semifinished fiber plate being an organic sheet heated by a heater to a temperature below a softening temperature of the thermoplastic, and the semifinished fiber plate being positioned on a mold that reproduces the three-dimensional shape. A fluid is then fed into the molding chamber so that the heated semifinished fiber plate is pressed against the molding module and is thus deformed into the three-dimensionally shaped thermoplastic semifinished product.

Other methods for processing organic sheets and/or parts made from such organic sheets are described in DE 10 2013 105 080, DE 10 2011 111 233, and DE 10 2011 111 232, for example.

Alternatively, DE 198 59 798 describes making molded bodies from fiber composite materials by the so-called prepreg method. Thin layers of fibers embedded in partially cured resin are laminated until a preform of the molded body has been created. This preform is subsequently cured under mechanical pressure with the simultaneous effect of a vacuum in order to draw off air bubbles from the preform by heating. This is typically performed in an autoclave where the preform lies on a negative mold and is covered by a flexible membrane. The flexible membrane is sealed off against the negative mold. A layer of woven material is also provided between the preform and the membrane and serves to absorb excess resin and to form a vacuum zone, the so-called vacuum bladder. The area of the vacuum bladder is connected to a vacuum source.

Taking this as a point of departure, DE 198 59 798 describes making molded bodies from fiber composite materials that builds upon an RTM method. A fiber mat is placed onto a rigid negative mold, and the fiber mat is covered with a flexible membrane. The membrane is sealed around the fiber mat relative to the negative mold, and the space between the negative mold and the membrane that is formed in this way is evacuated, and a static superatmospheric pressure is applied to the rear face of the membrane turned away from the negative mold. A quantity of liquid resin is then injected into the space between the negative mold and the membrane at an injection pressure that is greater than the superatmospheric pressure on the rear face of the membrane. The resin is heated on the rear face of the membrane by the heated negative mold under the effect of the superatmospheric pressure and cured at least partially. The superatmospheric pressure on the rear face of the membrane is then reduced, and the molded body with the fiber mat embedded into the at least partially cured resin is demolded. The negative mold can be continuously heated, and the membrane can be cooled on its rear face.

Similar methods in which a membrane press is used and a resin is injected into the mold space are described in EP 1 420 940 [US 2004/0219244] or DE 694 09 618, for example.

DE 40 40 746 (GB 2,243,104] describes a method of compressing, in a membrane press, a composite material body with a structure of fibers embedded in a matrix that reinforce uncompressed layers.

It is the object of the invention to provide a method of making (lightweight) parts from fiber composite materials of high quality and high stability.

To achieve this object, the invention teaches a method of making a part from a fiber composite material by deforming a thermoplastic organic sheet in a membrane press, where

a mold is provided in the membrane press and at least one organic sheet is placed against or onto the mold as a workpiece,

an elastically flexible membrane is flexibly stretched over the mold atop the organic sheet, and

the organic sheet is deformed so as to form the part by application of a subatmospheric pressure to the membrane on its face turned toward the mold and by application of a superatmospheric pressure to its face turned away from the mold, so that the organic sheet is shaped against the mold.

The invention proceeds in this regard from the insight that high-stability and high-precision three-dimensional fiber composite parts can be manufactured economically from organic sheets in a membrane press, with such organic sheets being available as (two-dimensional) plate-shaped consolidated semifinished products that are outstandingly suitable for deforming into three-dimensional structures by application of pressure and heat, which structures can be used in aircraft construction, automobile construction, or the like. Unlike in conventional prepreg methods, however, not only partially cured mats are used, but rather consolidated semifinished products in the form of organic sheets, so that there is no injection of liquid resins or the like into the press. Especially preferably, an organic sheet is used as a prefabricated semifinished product composed of a plurality of organic layers that are placed together and optionally joined together before introduction into the press. Highly stable parts can be produced in this way that can also have a certain thickness or wall thickness. Nonetheless, flawless shaping is achieved in the membrane press in the context of the invention, since a (highly) elastically flexible membrane is clamped into the press that is elastically stretched and clamped over the mold with interposition of the organic sheet. By the application of subatmospheric pressure on the one hand and superatmospheric pressure on the other hand, flawless shaping then occurs, with the highly elastic membrane stretching strongly and perfectly against the desired contour and, with interposition of the organic sheet, against the contour of the mold. With the application of subatmospheric pressure on the one hand and (very high) superatmospheric pressure on the other hand, it is possible to shape consolidated organic sheets into parts having a complex structure and small radii, so that even U-shaped profiles with and without undercut can be manufactured flawlessly, for example. The high pressures in the membrane press perfectly vents the workpiece so that the formation of pores is prevented and/or pores can be removed. Overall, the manufactured parts are characterized by very high surface quality and a high level of stability.

In this way, it is possible to produce highly stable, lightweight parts for aircraft construction, for example for support surfaces or support surface parts. For example, profiles can be produced that can be used as parts of landing flaps.

Organic sheets are preferably used whose fibers are carbon fibers, glass fibers, and/or aramid fibers. Thermoplastic plastics are especially preferably used that are stable at high temperatures, such as polyether ether ketone (PEEK) or polyphenylene sulfide (PPS). Alternatively, however, polypropylene (PP), polyamide (PA), or polyurethane (TPU) can also be used, depending on the requirements and area of application.

During manufacture, it is advantageous for the organic sheet to be heated before and/or after being introduced into the press in order to optimize the shaping process. It is advantageous for the organic sheet to be heated to a temperature above its glass transition temperature. Depending on the organic sheet and depending on the thermoplastic plastic, it can be advantageous to heat the organic sheet to a temperature of greater than 180° C., for example greater than 200° C.

Alternatively or in addition, it is advantageous to heat the mold or at least its surface turned toward the organic sheet before and/or during shaping. Here, too, it can also be advantageous to heat the mold, more particularly the outer surface thereof, to a temperature above the glass transition temperature of the thermoplastic plastic, for example to a temperature of greater than 180° C., for example greater than 200° C.

In addition, it is alternatively or additionally advantageous if the fluid medium with which pressure is applied to the membrane, such as a pressurized gas, for example, is heated in order to optimize the heat input and improve hot shaping.

According to the invention, not only is a subatmospheric pressure applied to the face of the membrane turned toward the mold, but rather a superatmospheric pressure is also applied to the face of the membrane turned away from it, with it being especially preferably possible for a superatmospheric pressure of at least 10 bar, for example at least 20 bar to be produced. According to the invention, high pressures are thus used to take into account the fact that consolidated organic sheets are being processed or shaped.

A vacuum bladder is not used for this purpose as is common with membrane presses when processing prepregs or for the injection of resin, but rather the highly elastic membrane is stretched over the mold. For example, it can be secured to the lower element of the press and stretched over the mold. Alternatively, however, the membrane can also be secured to the lower element of the press when elastically stretched and then stretched over the mold as the press is closed.

In principle, membranes made of rubber can be used. In consideration of the fact that plastics are preferably used that are stable at high temperatures, the invention recommends the use of a membrane that is made of a highly elastic yet thermally stable material such as silicone or a silicone-based material. Existing silicone membranes can be used that have a stretch-to-break of at least 500%, preferably at least 600%. The membrane preferably has a thickness of at least 1 mm, especially preferably at least 2 mm.

As described above, a prefabricated semifinished product composed of a plurality of organic layers or a large number of organic layers placed together before introduction into the press and optionally joined together is especially preferably used. It lies within the scope of the invention, however, for the organic layers to be placed together individually and pressed collectively. Preferably, however, the organic layers are previously joined together (in a desired arrangement), for example by welding and/or gluing, in which case an intimate bond is created subsequently during shaping in the membrane press. Alternatively, it lies within the scope of the invention for the individual organic layers to be combined into a unitary organic sheet in a prepress.

In that case, a large number of layers can be used, for example, five layers, preferably at least ten layers. For highly stable parts (for aircraft construction, for example), more than twenty layers can also be joined together to form one organic sheet.

It lies within the scope of the invention for individual layers having different fiber orientations to be used and/or for the individual layers to be stacked such that their fibers do not run parallel, but rather at a predefined angle. Especially stable organic sheets and corresponding parts can be produced in this way. The characteristics and geometry of the part can be influenced outstandingly by the selection and arrangement of the individual layers. For example, the possibility exists of providing individual layers in different sizes to form an organic sheet whose thickness varies over its surface. In areas in which more layers are present, for example, workpieces with a greater thickness or wall thickness are created than in other areas. Similarly, it is possible to arrange the individual layers such that a desired edge geometry of the part is created during deformation by offsetting of the individual layers relative to one another. For example, if the individual layers are arranged flush in the non-deformed state, a sloped edge geometry can be produced by the deformation and, conversely, a straight edge geometry can be achieved by a skew arrangement of the individual layers in the edge region as a result of deformation. It may be desirable, for example, to produce parts with beveled edges in order to make better joining surfaces available for further processing.

The object of the invention is also a press for making a part from a fiber composite material according to a method of the described type. Such a press is constructed as a membrane press having a lower element carrying a mold and having an upper element having a pressurizable hood whose interior can be sealed against the lower element. In addition, a membrane is provided that can be stretched over the mold.

The press also has at least one cylinder that acts on the upper and/or the lower element. In addition, the press has a vacuum pump with which a subatmospheric pressure can be generated on one face of the membrane, the underside, for example, and a pressure pump with which a superatmospheric pressure can be generated on the other face of the membrane.

The press can be set up such that the mold and/or the lower element can be heated and are thus equipped like a heater. In addition, in the press the fluid medium with which pressure is applied to the membrane can be heated by the provision of a heater near the infeed for the fluid medium, for example.

The possibility exists for the membrane to be secured to the lower element and stretched over the mold. Alternatively, it is possible for the membrane to be secured when elastically stretched to the upper element, for example to the pressurizable hood.

The invention is explained in further detail below with reference to a schematic drawing that illustrates only one embodiment.

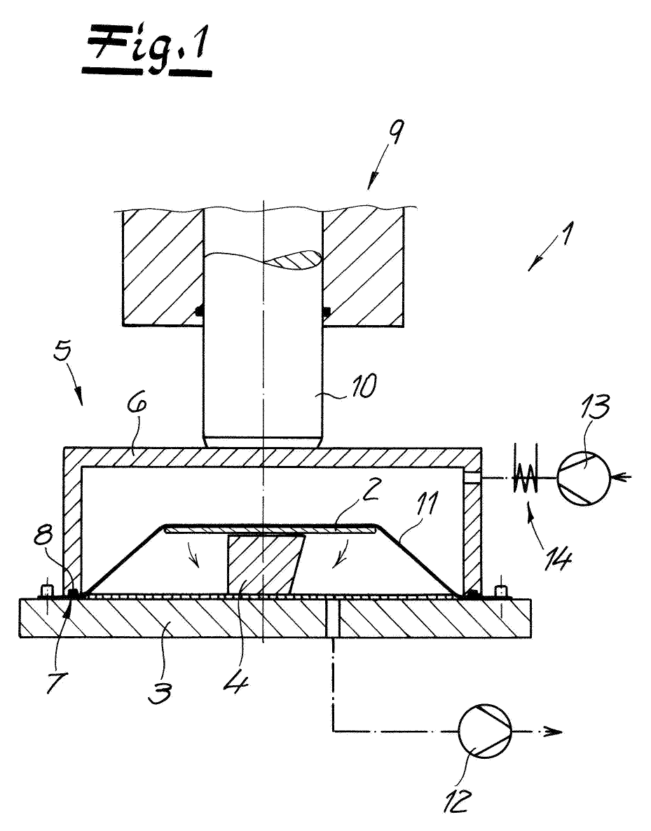

FIG. 1 is a simplified view of a membrane press according to the invention,

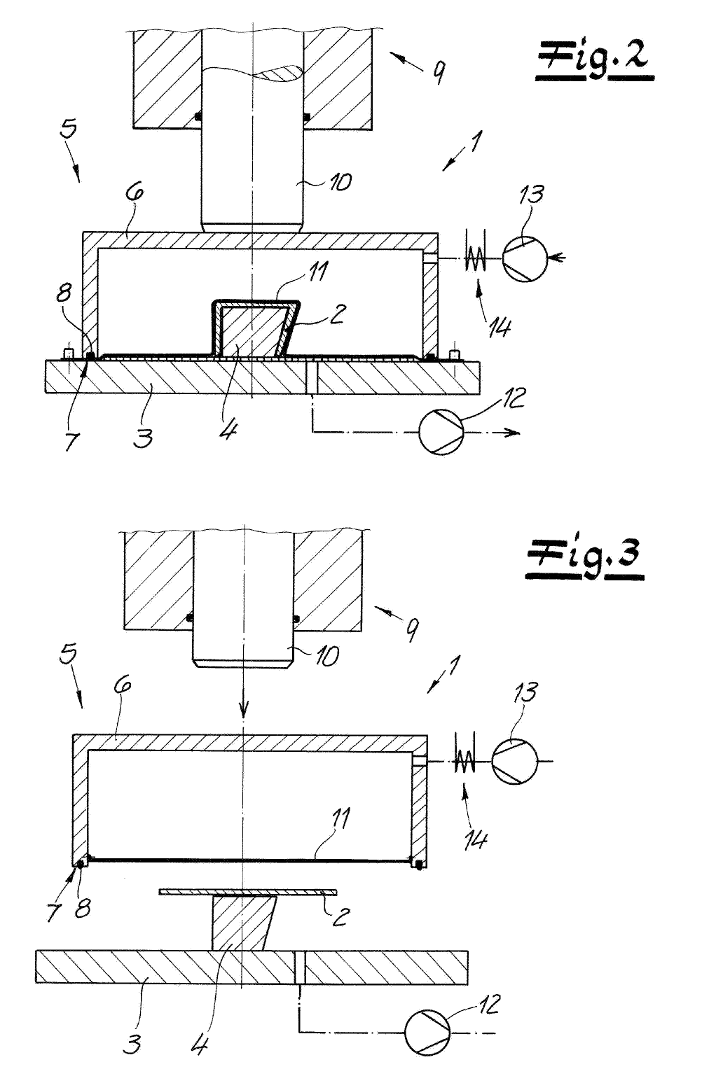

FIG. 2 is a view showing the press of FIG. 1 in another functional position,

FIG. 3 is a view like FIG. 1 but showing a modified embodiment of the press,

FIG. 4 is a view showing the press of FIG. 3 in another functional position,

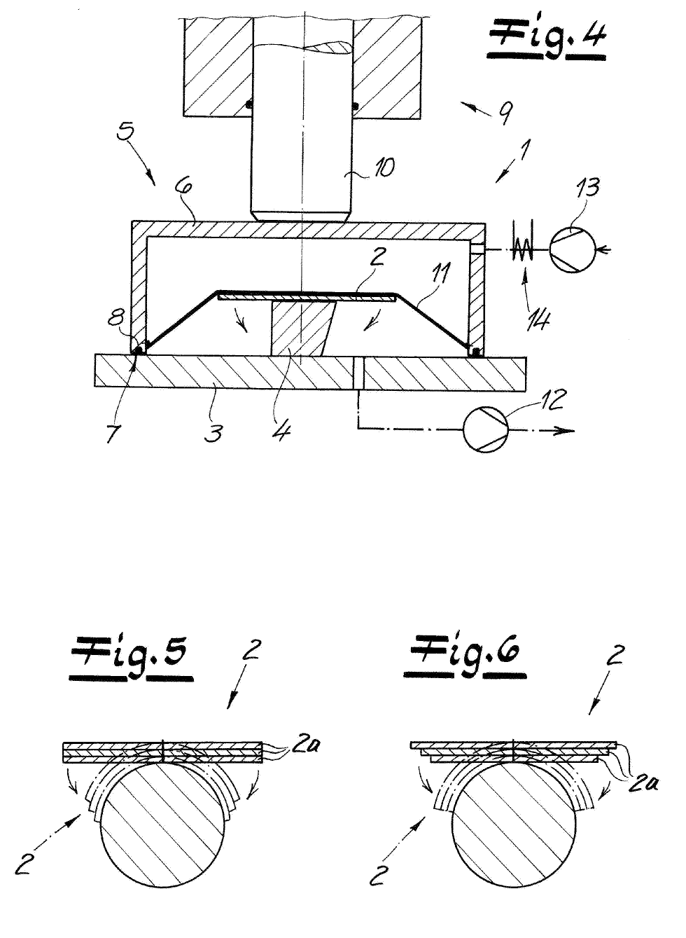

FIG. 5 shows a first embodiment of a process for shaping a multilayer organic sheet, and

FIG. 6 shows a second embodiment of a process for shaping a multilayer organic sheet.

The drawing shows a membrane press 1 for making a part from a fiber composite material. In such a membrane press, a part is manufactured from a fiber composite material by shaping of a thermoplastic organic sheet 2. In this embodiment, the membrane press 1 has a lower element 3 that is embodied as a press table on which a mold 4 is provided as a negative mold of the part to be made. In addition, the press 1 has an upper element 5 that has a pressurizable hood 6 that can be sealed off against the lower element 3. For this purpose, a lower, circumferential front edge 7 of the pressurizable hood 6 can be placed on the press table and is provided with a seal ring 8. A cylinder 9 acts on the upper element 5, and here a piston 10 of the cylinder 9 is connected to the pressurizable hood 6 so that the pressurizable hood 6 is pressed with the cylinder 9, more particularly the piston 10 thereof, against the lower element 3. In addition, the membrane press 1 is equipped with an elastically flexible membrane 11 that can be stretched over the mold 4. Furthermore, a vacuum pump 12 is provided that here is connected to the lower element 3. In addition, a pump 13 capable of generating a superatmospheric pressure is provided that, in this embodiment, is connected to the upper element 5 and/or to the pressurizable hood 6.

An organic sheet 2 is shaped by placing it onto the mold 4, and the membrane 11 is flexed and stretched over the mold 4 atop organic sheet 2.

The organic sheet is deformed so as to form the part by application of a subatmospheric pressure by the vacuum pump 12 to the membrane 11 on its face turned toward the mold 4 and by application of a superatmospheric pressure by a pressure pump 13 to its face turned away from the mold 4, so that the organic sheet 2 is shaped against the mold to form the part.

The organic sheet 2 is heated before being placed into the press 1. In addition, preferably the mold 4 or at least a surface thereof turned toward the organic sheet 2 is heated before and/or during the deformation. Finally, it is advantageous if the fluid medium with which superatmospheric pressure is applied to the membrane is heated. To achieve this, a heater 14 is shown in the drawing. Heaters for heating the organic sheet and for heating the mold are not shown.

FIG. 1 shows a first embodiment of such a membrane press in which the membrane 11 is secured to the lower element 3 and stretched over the mold 4. FIG. 1 shows the press after the organic sheet 2 has been placed onto the mold 4 and the membrane 11 has been stretched over the mold 4 with interposition of the organic sheet 2. In addition, after placing the organic sheet 2 and after stretching the membrane 11 on the lower element 3, the upper element 5 is lowered and sealed off. Subatmospheric pressure can be generated using the vacuum pump 12 before and/or after lowering of the upper element. After the upper element 5 has been lowered and sealed off against the lower element 3, the superatmospheric pressure is applied to the interior of the pressurizable hood 6. The compressive force with which the membrane press is held closed as the internal pressure increases can be increased successively with rising of the internal pressure and thus adapted thereto. FIG. 2 shows the press after the superatmospheric pressure and the subatmospheric pressure have built up, with the organic sheet 2 deformed.

FIGS. 3 and 4 show a modified embodiment of such a membrane press in which the membrane is not secured to the lower element 3 but rather to the upper element 5, namely to the pressurizable hood 7 thereof, and elastically stretched. After placing the organic sheet 2 onto the mold 4, the pressurizable hood 6 is lowered and, at the same time, the membrane is stretched over the mold with interposition of the organic sheet 2 (FIG. 4). After the press has been closed, the subatmospheric pressure and the superatmospheric pressure are built up, whereby the organic sheet 2 is deformed and the part produced.

The organic sheet 2 can be composed of a plurality of individual organic layers 2a that are laminated together to form the organic sheet 2 and deformed in the press. The geometry of the layers 2a can be coordinated with one another such that the individual layers 2a are offset relative to one another during the deformation, thereby altering the edge geometry of the part. This option is illustrated in FIGS. 5 and 6. According to FIG. 5, the individual layers 2a are placed together to form an organic sheet 2 with straight edges. During the deformation, the individual layers are offset relative to one another, so that a part with beveled edges is produced.

By contrast, FIG. 6 shows an embodiment in which the individual layers 2a of the organic sheet 2 do not lie flush over one another, but rather have offset outer edges so that a part with straight edges without bevels is then formed during the deformation.

1. A method of making a part from a fiber composite material, the method comprising the steps of
providing a mold a membrane press and placing at least one organic sheet onto or against the mold as a workpiece,
stretching an elastically flexible membrane over the mold on the organic sheet, and
deforming the organic sheet so as to form the part by
applying a subatmospheric pressure to the membrane on its face turned toward the mold and
applying a superatmospheric pressure to the face turned away from the mold and thereby shaping the organic sheet against the mold.

2. The method defined in claim 1, further comprising the step of:
heating the organic sheet before and/or after being placed into the press.

3. The method defined in claim 1, further comprising the step of:
heating the mold or at least a surface thereof turned toward the organic sheet before and/or during the deformation.

4. The method defined in claim 1, further comprising the step of:
heating the fluid medium with which superatmospheric pressure is applied to the membrane.

5. The method defined claim 1, wherein the superatmospheric pressure is at least 10 bar.

6. The method defined in claim 1, wherein the organic sheet is a prefabricated semifinished product composed of a plurality of organic layers that are placed together before being introduced into the press.

7. The method defined in claim 6, wherein the organic layers have different fiber orientations.

8. The method defined in claim 6, wherein the organic layers are of different sizes in order to form an organic sheet whose thickness varies over its surface.

9. The method defined in claim 1, wherein the membrane is made of silicone.

10. The method defined in claim 1, wherein the membrane has a thickness of at least 1 mm and/or a stretch-to-break of at least 500%.

11. The method defined in claim 6, wherein the organic layers are offset relative to one another during the deformation, thereby altering an edge geometry of the part.

12. A membrane press for making a part from a fiber composite material, the press comprising:
a lower element carrying a mold,
an upper element having a pressurizable hood that can be sealed off against the lower element,
at least one cylinder that acts on the upper element and/or the lower element to press the elements together,
a membrane that can be stretched over the mold,
a vacuum pump for applying a subatmospheric pressure to one face of the membrane, and
a pressure pump for applying a superatmospheric pressure to the other face of the membrane.

13. The press defined in claim 12, wherein the membrane is secured to the lower element and stretched over the mold.

14. The press defined in claim 12, wherein the membrane is secured when elastically stretched to the pressurizable hood.

15. The press defined in claim 14, wherein the membrane forms with the hood a closed upper chamber above the mold and connected to the pressure pump, and, when the upper element is pressed against the lower element, the membrane forms with the lower element a closed lower chamber connected to the vacuum pump.
